(19) United States
(12) Patent Application Publication
(10) Pub. No.: US 2024/0253488 A1
(43) Pub. Date: Aug. 1, 2024

(54) CABLE TENSION MANAGEMENT FOR ELECTRIC VEHICLE CHARGING

(71) Applicants: Grace A. LINWOOD, Riverside, CA (US); Susan Q. LINWOOD, Riverside, CA (US)

(72) Inventors: Grace A. LINWOOD, Riverside, CA (US); Susan Q. LINWOOD, Riverside, CA (US)

(21) Appl. No.: 18/422,943

(22) Filed: Jan. 25, 2024

Related U.S. Application Data
(60) Provisional application No. 63/441,510, filed on Jan. 27, 2023.

(51) Int. Cl. B60L 53/18; B60L 53/31; H01R 13/58; H01R 13/60

(52) U.S. Cl. CPC B60L 53/18; B60L 53/31; H01R 13/5804; H01R 13/60

(57) ABSTRACT

A system may be provided for cable tension management for charging an electric vehicle (EV) located proximate a power source attached to a first wall, a first support, or a first support beam, and a charging connector comprising a charging portion configured to be electrically connected to the power source, and a connection portion comprising an EV outlet charging interface configured to removably engage an EV inlet charging interface. The system may include a tension reducing device, attached to a second wall, a second support, or a second support beam, including a flexible support and a clamping element. The clamping element may be configured to couple the flexible support to the charging connector between the charging portion and the connection portion.

### CROSS-REFERENCE TO RELATED APPLICATIONS

The present application claims the benefit of U.S. Provisional Patent Application No. 63/441,510, entitled CABLE TENSION MANAGEMENT FOR ELECTRIC VEHICLE CHARGING, which was filed on Jan. 27, 2023 and is incorporated by reference as though set forth herein in its entirety.

### TECHNICAL FIELD

The present disclosure relates generally to systems and methods related to charging systems specifically adapted for electric vehicles. More particularly, to systems and methods for charging cable tension management for electric vehicle charging.

### BACKGROUND

As the adoption of electric vehicles continues to grow, the demand for convenient and accessible charging solutions is increasing. Current charging stations typically employ traditional cable management methods, where users manually handle and store charging cables during and after the charging session. This practice often results in cable wear and tear, potential safety hazards, electric connector wear and tear, and an overall suboptimal charging experience.

Additionally, the existing systems lack features for efficient and safe cable management, resulting in cluttered charging stations, potential tripping hazards, and difficulties in locating available charging connectors. There is, therefore, a need for cable tension management systems and methods for electric vehicle charging that overcome these limitations.

### SUMMARY

The various systems and methods of the present disclosure have been developed in response to the present state of the art, and in particular, in response to the problems and needs in the art that have not yet been fully solved by currently available systems and methods for cable tension management for electric vehicle charging.

In some embodiments, a system may be provided for cable tension management for charging an electric vehicle (EV) located proximate a power source attached to a first wall, a first support, or a first support beam, and a charging connector comprising a charging portion configured to be electrically connected to the power source, and a connection portion comprising an EV outlet charging interface configured to removably engage an EV inlet charging interface. The system may include a tension reducing device, attached to a second wall, a second support, or a second support beam, including a flexible support and a clamping element. The clamping element may be configured to couple the flexible support to the charging connector between the charging portion and the connection portion.

In the system of any preceding paragraph, the system may have a storage position and a charging position.

In the system of any preceding paragraph, the power source, the tension reducing device, and the clamping element may be located in relation to each other so that, in the charging position, tension applied to the EV inlet charging interface by the EV outlet charging interface may be reduced or eliminated.

In the system of any preceding paragraph, the clamping element may be insulated.

In the system of any preceding paragraph, the clamping element may include an insulator material and a semi-rigid portion.

In the system of any preceding paragraph, the tension reducing device may include a positioner or a balancer.

In the system of any preceding paragraph, the charging portion may have a greater length than the connection portion.

In the system of any preceding paragraph, the length of the connection portion may be configured so that the flexible support supports the charging connector in a configuration that reduces or eliminates tension exerted on the charging connector and the EV outlet charging interface in a charging position.

In the system of any preceding paragraph, a length of the charging portion may be greater than a length of the flexible support.

In the system of any preceding paragraph, the first wall, the first support, or the first support beam may be the same wall, support, or support beam as the second wall, the second support, or the second support beam.

In some embodiments, a system may be provided for cable tension management for charging an electric vehicle (EV) located proximate a power source attached to a first wall, a first support, or a first support beam, and a charging connector comprising a charging portion configured to be electrically connected to the power source, and a connection portion comprising an EV outlet charging interface configured to removably engage an EV inlet charging interface. The system may include a tension reducing device, attached to a second wall, a second support, or a second support beam, including a flexible support and a clamping element. The system may have a storage position and a charging position. The clamping element may be coupled to the charging connector and may bisect the charging connector into the charging portion and the connection portion. The length of the connection portion may be configured so that the flexible support supports the charging connector in a configuration that reduces or eliminates tension exerted on the connection portion and the EV outlet charging interface in the charging position.

In the system of any preceding paragraph, the power source, the tension reducing device, and the clamping element may be located in relation to each other so that, in the charging position, tension applied to the EV inlet charging interface by the EV outlet charging interface is reduced or eliminated.

In the system of any preceding paragraph, the tension reducing device may include a positioner or a balancer.

In the system of any preceding paragraph, the charging portion may have a greater length than the connection portion.

In the system of any preceding paragraph, a length of the charging portion may be greater than a length of the flexible support.

In the system of any preceding paragraph, the clamping element may be insulated.

In the system of any preceding paragraph, the clamping element may include an insulator material and a semi-rigid portion.

In some embodiments, a method for cable tension management for electric vehicle (EV) charging ma include: anchoring a tension reducing device to a wall or a support using an offset anchor point that is offset at a distance, less than a length of a charging connector or cable, from a power source, wherein the charging connector includes a first end electrically connected to an EV outlet charging interface and a second end electrically connected to the power source; attaching a clamping element to the charging connector at an offset distance from the EV outlet charging interface; extending the EV outlet charging interface of the charging connector while applying a downward force to a retractable, flexible support that may extend from the tension reducing device, wherein the flexible support may extend away from the tension reducing device ipsilaterally relative to an EV inlet charging interface of the EV; and performing at least one of: suspending a weight of the EV outlet charging interface and attached charging connector from the clamping element and flexible support, wherein tension may be reduced or eliminated as a result of suspending the weight of the EV outlet charging interface and the offset attachment of the clamping element, and continuing to apply the downward force during charging until charging the EV is complete and the EV outlet charging interface may be released, automatically retracting the flexible support into the tension reducing device.

In the method of any preceding paragraph, the method may further include applying an upward force to the EV outlet charging interface and the flexible support.

In the method of any preceding paragraph, the method may further include bringing the EV outlet charging interface and the charging connector into a storage position.

### BRIEF DESCRIPTION OF THE DRAWINGS

The advantages, nature, and additional features of exemplary embodiments of the disclosure will become more fully apparent from the following description and appended claims, taken in conjunction with the accompanying drawings. Understanding that these drawings depict only exemplary embodiments and are, therefore, not to be considered limiting of the disclosure's scope, the exemplary embodiments of the disclosure will be described with additional specificity and detail through use of the accompanying drawings in which:

FIG. 1A is a diagram of a system for cable tension management for electric vehicle (EV) charging, according to one embodiment;

FIG. 1B is a detailed view of a clamping element of the system of FIG. 1A;

FIG. 2 is an alternative perspective view of the system of FIG. 1A;

FIG. 3 is a partial diagram and relational view of the system of FIG. 1A;

FIG. 4 is a detailed alternative perspective view of an electric charging connector of the system of FIG. 1A;

FIG. 5 is a partial cut-out view of the tension reducing device of FIG. 1A;

FIG. 6 is a flowchart of a method for cable tension management for EV charging; and

FIG. 7 is a flowchart of a method including additional optional steps for cable tension management for EV charging.

FIG. 8 is a diagram of a system for cable tension management for electric vehicle (EV) charging, according to one embodiment;

FIG. 9 is an alternative perspective view of the system of FIG. 8;

FIG. 10 is a detailed alternative perspective view of an electric charging connector of the system of FIG. 8;

FIG. 11 is a partial diagram and relational view of a system for cable tension management for electric vehicle (EV) charging, according to one embodiment;

FIG. 12 is a partial diagram and relational view of a system for cable tension management for electric vehicle (EV) charging, according to one embodiment;

FIG. 13 is a partial diagram and relational view of a system for cable tension management for electric vehicle (EV) charging, according to one embodiment.

### DETAILED DESCRIPTION

Exemplary embodiments of the disclosure will be best understood by reference to the drawings, wherein like parts are designated by like numerals throughout. It will be readily understood that the components, as generally described and illustrated in the Figures herein, could be arranged and designed in a wide variety of different configurations. Thus, the following more detailed description of the embodiments of the apparatus, system, and method is not intended to limit the scope of the invention, as claimed, but is merely representative of exemplary embodiments of the technology.

Standard vehicle planes of reference and descriptive terminology are employed in this specification. While these terms are commonly used to refer to the system for electric vehicle (EV) charging, certain terms are applicable to subsystems, additional objects or methods in general.

A standard system of three mutually perpendicular reference planes is employed. A longitudinal plane divides a vehicle (e.g., electric vehicle (EV)) into right and left portions. A transverse plane divides a vehicle into front and rear portions. A horizontal or supporting plane is defined just under the undercarriage portions of the vehicle. The intersection of the longitudinal and transverse planes defines a yaw or Z-axis. The intersection of the longitudinal and horizontal planes defines a roll or X-axis. The intersection of the horizontal and transverse planes defines a pitch or Y-axis. The yaw axis, roll axis, and the pitch axis are mutually perpendicular.

Fore means toward the front of a vehicle. Aft means toward the back of a vehicle. Upward means toward the roof or ceiling of the vehicle. Downward means toward the floor or support plane of the vehicle. Heading means yaw angle. Laterally means left or right along the Y-axis. Horizontally means fore or aft along the longitudinal axis. Axial means toward a central axis of a vehicle. Abaxial means away from a central axis of a vehicle. Ipsilateral means on the same side of the vehicle. Contralateral means on the opposite side of the vehicle. Proximal means toward a user or operator (e.g., where they would be located if in the vehicle). Distal means away from a user or operator.

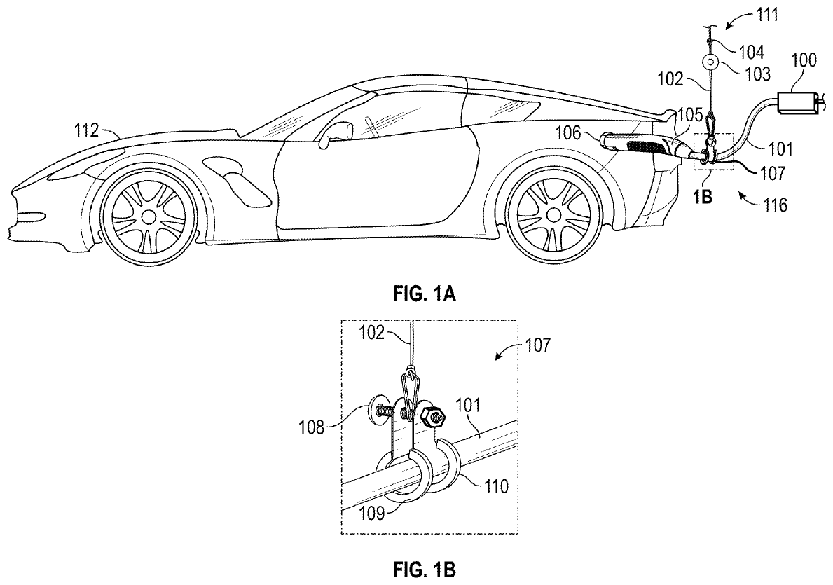

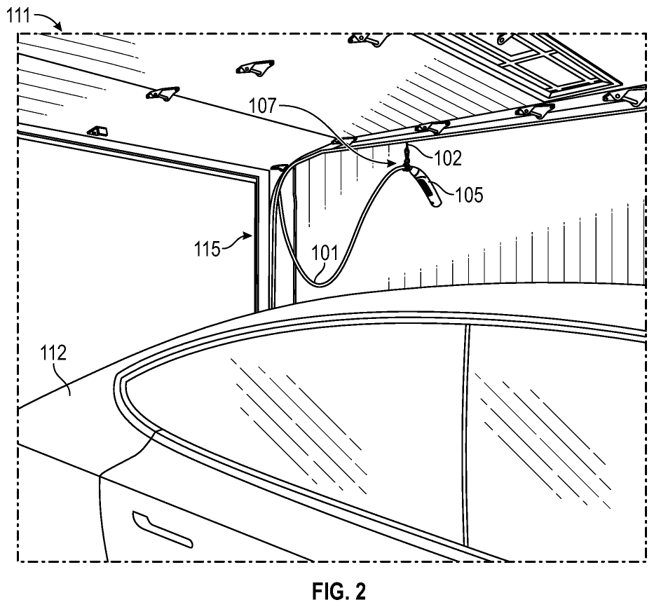

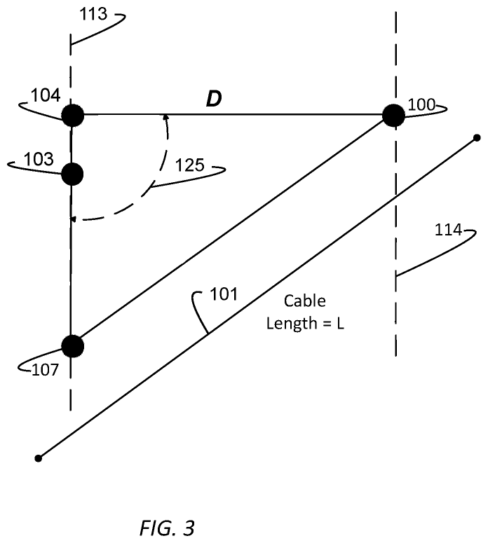

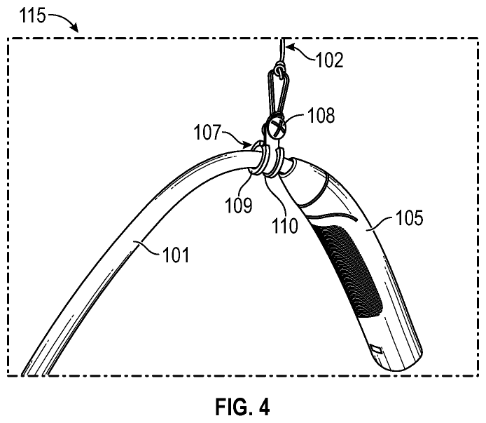

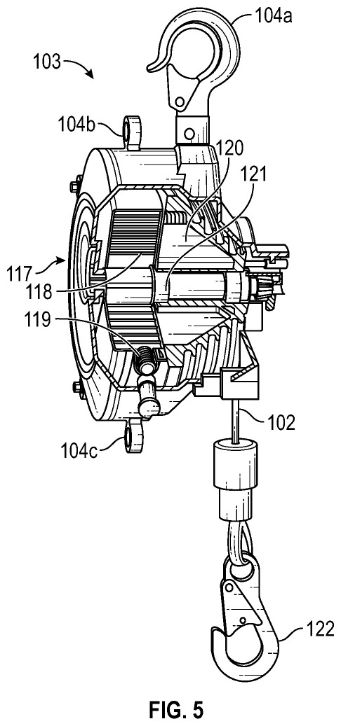

Referring to FIGS. 1A and 1B, a system 111 for cable management for EV charging is shown, according to one embodiment of the present disclosure. Specifically, FIG. 1A is a diagram of system 111, and FIG. 1B is a detailed view of a clamping element 107 of the system 111. FIG. 2 is a perspective view of system 111. FIG. 3 is a partial diagram and relational view of the system 111. FIG. 4 is a detailed alternative perspective view of a connection portion of the system 111. FIG. 5 is a partial cut-out view of the tension reducing device 103 (e.g., positioner/balancer) of system 111.

As shown in FIG. 1A, the power source 100 (also known as an EV charger) may be configured to be connected to the EV 112 to charge the EV 112 using a charging connector 101 (also known as a charging cable). A retractable, flexible support 102 may extend partially downward from a tension reducing device 103 to mechanically support the charging connector 101, which is depicted in a charging position 116 in FIG. 1A. The tension reducing device 103 may be secured to a wall, a support, or a support beam using an offset anchor point 104. A proximal end of the charging connector 101 may include an EV outlet charging interface 105 for insertion into an EV inlet charging interface 106 of the EV 112. A clamping element 107 may be attached to a proximal end of the charging connector 101 at a distance that is less than a length of the charging connector 101 (e.g., see FIG. 3) to support the charging connector 101 at an offset position and in a configuration that reduces or eliminates the tension experienced by the charging connector 101 during charging.

Although single elements are depicted in FIG. 1A, such as a single charging connector 101, tension reducing device 103, and EV outlet charging interface 105, this depiction is not limiting. For example, multiple connectors, tension reducing devices, and EV outlet charging interfaces may be used in system 111, such as with charging multiple EVs, charging contralaterally, or charging from opposite sides of the EV 112.

As shown in FIG. 1B, the system 111 may further have a fastener 108 (e.g., bolt, screw, nut, wire, zip-tie, etc.) attached to the clamping element 107 to secure the clamping element 107 to the charging connector 101. In some embodiments, the fastener 108 is a removable fastener. In other embodiments, the fastener 108 is a fixed or non-removable fastener, such as a weld. An interior portion of the clamping element 107 may include an insulator material 109 to prevent wear and tear to the charging connector 101 and to prevent inadvertent transfer of electricity to a user or a semi-rigid portion 110 of the clamping element 107. The semi-rigid portion 110 may be sized and shaped to permit secure and/or adjustable attachment to the charging connector 101. In some embodiments, the semi-rigid portion 110 may include metal, plastic, carbon fiber, nylon, or combinations thereof. The semi-rigid portion 110 may include two separate halves of a single clamp. In other embodiments, the semi-rigid portion 110 may include a single, unitary body, which together with the insulator material 109, makes up the clamping element 107. The semi-rigid portion 110 may have holes formed therein for receiving the fastener 108 to tighten the unitary body portion around the charging connector 101.

At least some portions or components of the clamping element 107 may be configured to facilitate various sizes (e.g., diameters) of charging connectors 101. For example, the holes in the semi-rigid portion 110 may include various sized holes, each being large or small enough to accommodate fasteners 108 of various shapes and sizes and being accompanied with various sized washers to further facilitate the use of the different fasteners 108. By way of another example, a connector opening of the clamping element 107 may be adjustable, such as by way of flexing or bending of the semi-rigid material of the semi-rigid portion 110 or by way of making adjustments to the adjustable portions of the clamping element 107 (e.g., bolt, nuts, screws, etc.).

Optionally, the clamping element 107 may be combined with other clamping elements (not shown) on a single charging connector 101, in order to further reduce the tension experienced by the charging connector 101 during charging of the EV 112. In the alternative, the clamping element 107 may be a “standalone” support designed to function (together with the flexible support 102) without the need for additional clamping elements along the length of the charging connector 101.

The proximal end of the charging connector 101 may have one or more features that facilitate insertion of the EV outlet charging interface 105 into the EV inlet charging interface 106 for charging. For example, the proximal end of the charging connector 101 may include contacts, terminals, sockets, neutral grounding, insulated shutters, or combinations thereof.

The distal end of the charging connector 101 and the power source 100 may include one or more additional features to facilitate connection and charging. For example, the power source 100 may include capacitors, transformers, resistors, wires, or other electronic parts operably connected between the power source 100 and the distal end of the charging connector 101. By way of another example, the power source 100 may include a battery management system and/or charge controller to oversee the controller commands and functions (e.g., trickle charging, float charging, etc.) that are potentially utilized during charging of the EV 112, such as on/off controls, power metering, power usage, data storage, real-time event data, and combinations thereof. By way of yet another example, the power source 100 may include a network controller for communication between various local components of the system 111 and/or remote components of a network (e.g., server, database, etc.).

The power source 100 may further have one or more features that facilitate visualization and/or display before, during, or after charging. For example, power source 100 may have a user interface operably connected to the power source 100. For example, an LED, LCD, or other type of display may be operably connected to a touchpad, a keypad, capacitive touch element, trackball, mouse, speaker and microphone, or similar I/O device for calibrating, initializing, adjusting, or otherwise using the power source 100 for charging the EV 112.

As shown in FIG. 2, the charging power source 100 may be located relative to the EV 112. The relative position may be fore, aft, abaxial, distal relative to the EV 112, or combinations thereof. Notably, the system 111 may be used in a wide variety of settings, including but not limited to residences, commercial establishments, auto service stations, gas stations, parking areas, and/or the like. The system 111 may be located indoors (for example, in a garage) or outdoors. In some embodiments, where multiple vehicles are to be charged at the same time, multiple systems 111 may be placed in close proximity to one another, and may optionally share components such as the charging power source 100 and/or structural components needed to support the tension reducing device 103 and/or the offset anchor point 104. The relative position may depend on the configuration, layout, and spatial availability of the residential charging space (e.g., garage), commercial charging space (e.g., parking lot), street charging space, or additional factors known to those skilled in the art.

The charging connector 101 of system 111 may be positioned to reduce or eliminate tension experienced by the charging connector 101 during use. For example, the clamping element 107 may be attached to the proximal end of the charging connector 101, near the EV outlet charging interface 105, and at a distance that is less than the length of the charging connector 101. The proximity of the clamping element 107 to the EV outlet charging interface 105 may vary depending on the weight of the EV outlet charging interface 105. For example, for heavier plugs, the clamping element 107 may be about two to five centimeters from the base of the plug. For lighter plugs, the clamping element may be from two to ten centimeters from the base of the plug. The charging connector 101 may be located in a storage position 115 that does not interfere with a walkway or pedestrian traffic area due to the use, placement, and configuration of the tension reducing device 103 (not shown in FIG. 2), offset anchor point 104 (not shown in FIG. 2), and clamping element 107.

The charging power source 100 may include a direct current (DC) or alternating current (AC) power source. According to some examples, the power source 100 may include a battery or battery array, residential or commercial power outlet, solar power source, or combinations thereof. In other embodiments, the charging power source 100 may include an EV charge box or charge station that is manufactured according to the specifications of the manufacturer of the EV 112.

According to some examples, the charging connector 101 may be in the form of an electric cable, wire, group of wires, conduit, or combinations thereof. The charging connector 101 may include a jacket material, such as a urethane, polyurethane, rubber, plastic, nylon, another insulator material, or combinations thereof. The charging connector 101 may be rated for various voltages ranging from 100, 200, 220, 230, 240, 300, 400, 450, 500, 600 Volts, or more, and various currents ranging from 32, 63, 125 amps, and more. The charging connector 101 may also be configured for different power supplies ranging from 2 kW, 7 kW, 11 kW, 22 kW, 50 kW, or more. The charging connector 101 may have a single or multiple conductors of the same or different gauges. For example, the charging connector 101 may have two 18-gauge conductors, three, four, or up to five 2-gauge conductors. Different numbers, electric ratings, and combinations thereof of conductors will be recognized by those skilled in the art and are included herein.

The flexible support 102 may be selected from various load-bearing flexible supports, including a cord, strap, rope, support cable, and combinations thereof. In other embodiments, the flexible support 102 may include a mechanical wire or cable that is spooled, coiled, or wound around a portion of the tension reducing device 103.

According to some examples, the tension reducing device 103 may be selected from any one of a biased spool, pulley, retractor, positioner, or balancer. In other embodiments, the tension reducing device 103 may be configured to allow the EV outlet charging interface 105 to maintain a stable, extended position despite being released by the operator. The EV outlet charging interface 105 may then be retracted after additional manipulation by the operator. For example, the tension reducing device 103 may comprise a ratchet locking tool balancer, an inertial locking retractor, a coiled spring positioner with safety locking pin, or similar device that may be manipulated by the user to retract the flexible support 102 when the user is done using the EV outlet charging interface 105.

The proximal end of the charging connector 101 may include the EV outlet charging interface 105 configured for insertion into one specific or multiple EV inlet charging interfaces 106 of the EV 112. For example, a plug at the proximal end of the charging connector 101 may be interchangeable with a different plug to interface with different ports, outlets, or sockets of the EV inlet charging interface 106 (or of different EVs 112). By way of another example, the plug may have a different number of pins or a specific shape depending on the type or version of the charging socket/plug. The plug may be configured for/as a North American Type 1 combined charging standard (CCS) (SAE J1772), a European Type 2 CCS (IEC 62196), a Tesla Model S, Model X, CCS and/or ChaDeMo adaptor, a Japanese ChaDeMo, a NEMA 14-SOP socket, or according to similar plug/socket charging standards.

The tension reducing device 103 may be secured at one or more offset anchor points 104 using a wall anchor, nail, screw, bolt, nut, or combination of these or similar fasteners. At least one of the offset anchor points 104 may be offset relative to the power source 100. The attachment location of the clamping element 107 may be substantially vertically aligned with the offset anchor point 104 and tension reducing device 103 when in a storage position 115. For example, referring now to FIG. 3, the at least one offset anchor point 104 may be positioned at a distance, D, relative to the charging power source 100. The charging power source 100, the at least one offset anchor point, and the clamping element 107 may define an angle 125. In some embodiments, the distance, D, is less than or equal to the length of the charging connector 101, L, and the angle 125, is between 70 and 110 degrees, inclusive. In other embodiments, the distance, D, is less than the length of the charging connector 101, L, and the angle 125, is about 90 degrees.

A first vertical axis 113 passing vertically through the at least one offset anchor point 104 may be parallel with the yaw axis and may be in substantial horizontal alignment with the clamping element 107 when the charging connector 101 assumes the charging position 116. A second vertical axis 114 passing vertically through the charging power source 100 may also be parallel with the yaw axis of the vehicle. The second vertical axis 114 may be separated from the first vertical axis 113 by a distance that is less than or equal to the distance, D. The exact separation distance between the first vertical axis 113 and second vertical axis 114 may be determined using trigonometric functions, mathematical calculations, measurements, or with other similar devices and/or means. In some embodiments, the angle 125, is determined relative to the first vertical axis 113, the horizontal distance between the first vertical axis 113 and second vertical axis 114, and/or the distance, D.

Referring now to FIG. 4, a detailed view of the clamping element 107 attached to the charging connector 101 is depicted while the charging connector 101 and the EV outlet charging interface 105 assume a storage position 115. In some embodiments, the storage position 115 allows the EV outlet charging interface 105 to be approximately horizontally and vertically or laterally and vertically aligned with the charging position 116 depicted in FIG. 1A. In other embodiments, the storage position 115 is at least horizontally aligned with the charging position 116, but not vertically aligned. In yet other embodiments, the storage position 115 is at least horizontally aligned but not laterally aligned with the charging position 116.

According to some examples, the clamping element 107 includes the insulator material 109 and the semi-rigid portion 110 configured to be secured around, on, partially around, or partially on the charging connector 101. The insulator material 109 may include rubber, nylon, plastic, fiberglass, wood, or similar insulator materials. The semi-rigid portion 110 may include a retainer clip, clamp clip, nylon zip-tie, conduit clamp, or combinations thereof. Although in some embodiments the semi-rigid portion 110 may be somewhat flexible or bendable to accommodate tightening or loosening relative to different sizes of charging connectors 101, in other embodiments, the semi-rigid portion 110 may be completely rigid and adjustable, such as with a threaded U-bolt and nuts.

As shown in FIG. 5, the tension reducing device 103 may include multiple locations, structures, or features for various anchor points 104a, 104b, and 104c. The various anchor points 104a, 104b, and 104c are for different types or locations of anchoring, such as removable anchoring, fixed anchoring, ceiling anchoring, wall anchoring, or combinations thereof. The tension reducing device 103 may also include additional features, structures, or components for adjustable, retractable, or stable positioning of the charging connector 101 and EV outlet charging interface 105. For example, the tension reducing device 103 may include a tension gauge 117, a spring and spring case 118, a safety device pin 119, a spool element or tapered drum 120 for storing or releasing the flexible support 102, a ball bearing and spindle assemble 121, and a hook 122 (with an optionally attached rubber buffer/collar).

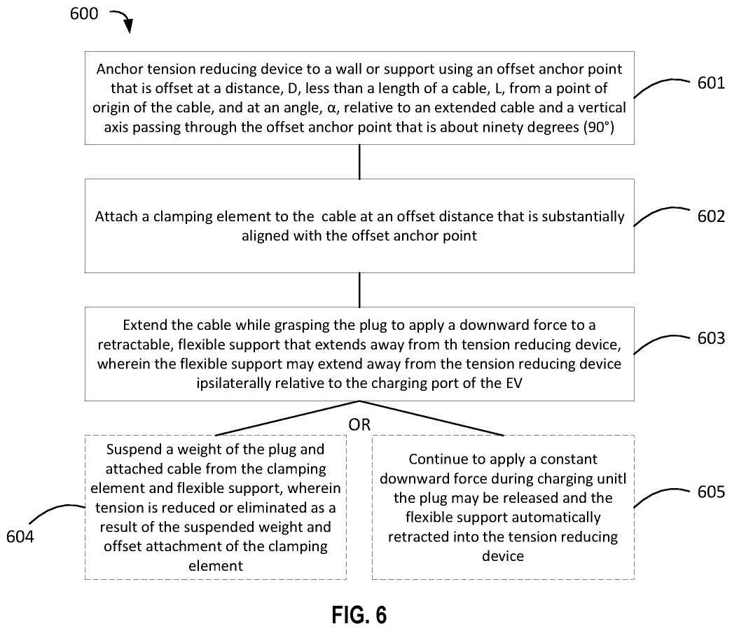

FIG. 6 is a flow chart of a method 600 for cable tension management for EV charging. In general, method 600 involves securing a tension reducing device at a location relative to a charging connector to reduce the tension experienced by the charging connector during the charging of an EV. For example, Step 601 includes anchoring a tension reducing device that has a spool/coil (e.g., as found within a balancer, retractor, and/or positioner) to a wall or support at an offset anchor point (i.e., offset relative to the power source or point of origin of the charging connector). The offset anchor point is at a distance, D, from the point of origin (e.g., EV charge box) of the charging connector that is less than a length of the charging connector, L. The offset anchor point is also at an angle 125, relative to the charging connector in an extended or charging position, the point of origin, and/or a vertical axis passing through the offset anchor point. The angle 125, is about ninety degrees (90º).

Once the tension reducing device is anchored, method 600 may proceed to step 602, in which a user attaches a clamping element to the charging connector at an offset distance that is substantially aligned with the offset anchor point. For example, in a storage position, the clamping element may be substantially horizontally and/or vertically aligned with the offset anchor point.

Once the clamping element is attached, method 600 may proceed to step 603 in which the user extends the charging connector by grasping the plug and pulling. A downward force is simultaneously applied to the retractable, flexible support that protrudes from the tension reducing device during the extension of the charging connector. The flexible support may be extended away from the tension reducing device ipsilaterally relative to the charging port of the EV (e.g., depending on where the charging port is located on the EV).

Once the charging connector is extended, the method proceeds to an optional step 604 or an optional step 605, depending on how the tension reducing device is configured (e.g., as a positioner, balancer, and/or retractor). For example, if the tension reducing device is a positioner or a balancer, the method 600 proceeds to optional step 604, in which a user suspends the weight of the plug and attached cable from the clamping element and flexible support. The tension is reduced or eliminated (relative to conventional charging stations and/or configurations) as a result of the suspended weight and the offset attachment of the clamping element. By way of another example, if the tension reducing device is a retractor, the method 600 proceeds to optional step 605 in which a user, or the force of the plug inserted/fitted into the charge port of the EV, continues to apply a constant downward force during the charging. Once the EV is charged, the plug is removed from the charge port and the flexible support automatically retracts into the tension reducing device. A user may optionally apply an upward force during the automatic retraction to aid in a faster spooling, coiling, and/or retracting of the flexible support into the tension reducing device.

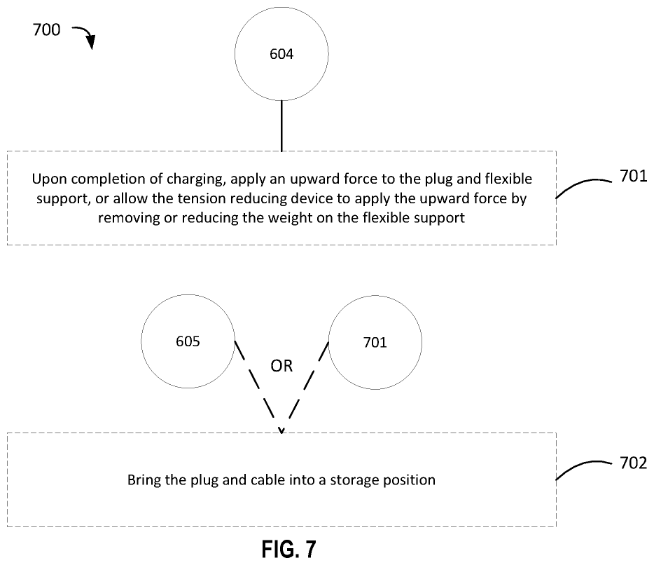

FIG. 7 is a flow chart of a method 700 for additional optional steps for cable tension management for EV charging. In general, method 700 involves steps that may be performed after the steps of method 600. For example, step 701 includes, upon completion of charging, the user applying an upward force to the plug and flexible support (or otherwise manipulates the pin or locking mechanism of a spool of the tension reducing device to release the locking mechanism) or allowing the spool/spring-coil to apply the upward force by removing or reducing the weight on the flexible support.

Again, depending on the configuration of the tension reducing device, method 700 may proceed from step 605 or step 701 to step 702 in which the user brings the plug and charging connector into a storage position. The storage position removes the charging connector from pathways, walkways, or spaces directly adjacent to the EV such that a user may not trip or otherwise be encumbered by the charging connector.

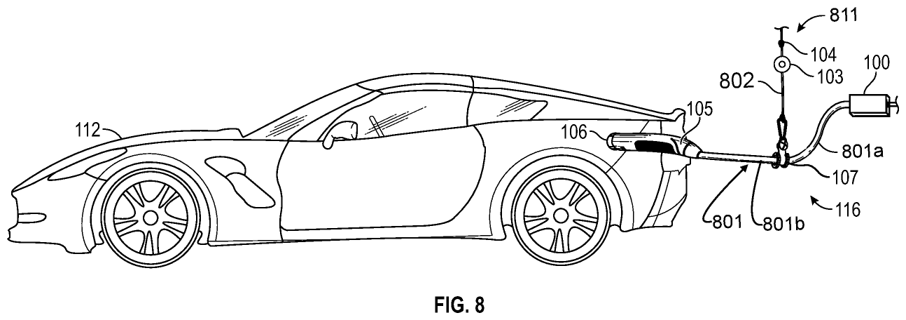

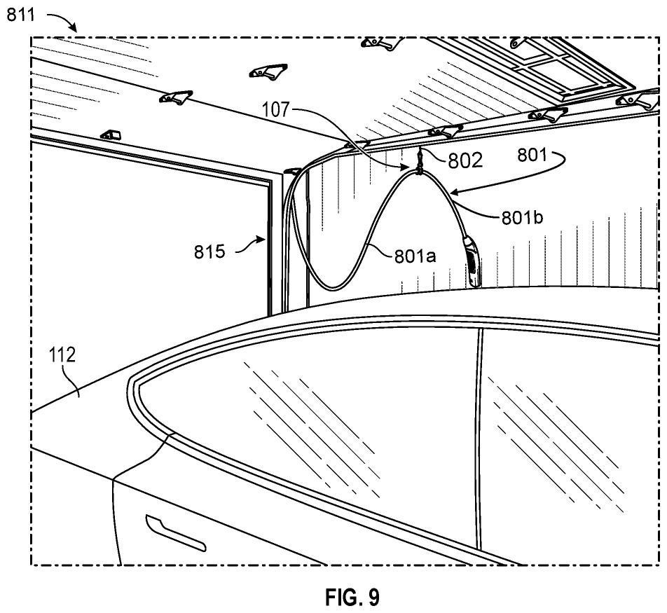

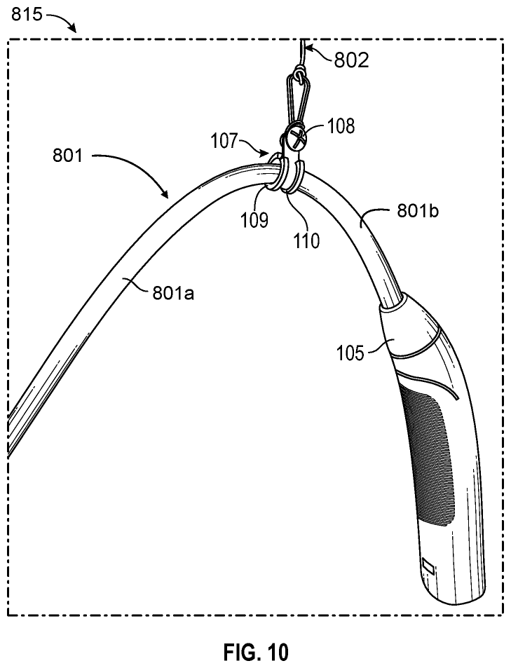

FIG. 8 is a diagram of a system 811 for cable tension management for electric vehicle (EV) charging, according to one embodiment. FIG. 9 is an alternative perspective view of the system 811. FIG. 10 is a detailed alternative perspective view of a charging connector 801 of the system 811.

As shown in FIG. 8, the power source 100 (also known as an EV charger) may be configured to be connected to the EV 112 to charge the EV 112 using a charging connector 801 (also known as a charging cable). A retractable, flexible support 802 may extend partially downward from a tension reducing device 103 to mechanically support the charging connector 801, which is depicted in a charging position 816 in FIG. 8. The tension reducing device 103 may be secured to a wall, a support, or a support beam using an offset anchor point 104. A proximal end of the charging connector 801 may include an EV outlet charging interface 105 for insertion into an EV inlet charging interface 106 of the EV 112.

A clamping element 107 may be attached to the charging connector 801. The charging connector 801 may include a charging portion 801a and a connection portion 801b. The charging portion 801a may include the length of the charging connector 801 between the power source 100 and the clamping element 107. The connection portion 801b may include the length of the charging connector 801 between the clamping element 107 and the EV outlet charging interface 105. The length of the charging connector 801 may generally be equal to the length of the charging portion 801a plus the length of the connection portion 801b. In an embodiment, the charging portion 801a may have a greater length than the connection portion 801b. The clamping element 107 may bisect the charging connector 801 into a charging portion 801a and a connection portion 801b.

The length of the connection portion 801b may be configured so that the flexible support 802 may support the charging connector 801 in a configuration that reduces or eliminates the tension exerted on the connection portion 801b and the EV outlet charging interface 105 in a charging position 816. The length of the charging portion 801a may be greater than the length of the flexible support 802.

As shown in FIG. 9, the charging power source 100 may be located relative to the EV 112. The relative position may be fore, aft, abaxial, distal relative to the EV 112, or combinations thereof. Notably, the system 811 may be used in a wide variety of settings, including but not limited to residences, commercial establishments, auto service stations, gas stations, parking areas, and/or the like. The system 811 may be located indoors (for example, in a garage) or outdoors. In some embodiments, where multiple vehicles are to be charged at the same time, multiple systems 811 may be placed in close proximity to one another, and may optionally share components such as the charging power source 100 and/or structural components needed to support the tension reducing device 103 and/or the offset anchor point 104. The relative position may depend on the configuration, layout, and spatial availability of the residential charging space (e.g., garage), commercial charging space (e.g., parking lot), street charging space, or additional factors known to those skilled in the art.

The charging connector 801 of system 811 may be positioned to reduce or eliminate tension experienced by the charging connector 801 during use. For example, the clamping element 107 may be attached at a distance from the EV outlet charging interface 105 that is less than the length of the charging connector 801. The proximity of the clamping element 107 to the EV outlet charging interface 105, or length of the connection portion 801b, may vary depending on the weight of the EV outlet charging interface 105.

Additionally, or alternatively, the length of the connection portion 801b may vary depending on the distance of the tension reducing device 103 from the supporting plane of the electric vehicle (EV) 112. More specifically, the length of the connection portion 801b may be less than the distance from the tension reducing device 103 to the supporting plane of the electric vehicle (EV) 112 so that when the system 811 is in the storage position 815, the EV outlet charging interface 105 does not contact the supporting plane.

Alternatively, the length of the connection portion 801b may be configured so that the EV outlet charging interface 105 is generally the same distance from the supporting plane of the EV 112 as the distance from the EV inlet charging interface 106 to the supporting plane when the system 811 is in the storage position 815. Additionally, the charging connector 101 may be located in a storage position 815 that does not interfere with a walkway or pedestrian traffic area due to the use, placement, and configuration of the tension reducing device 103 (not shown in FIG. 9), offset anchor point 104 (not shown in FIG. 9), and clamping element 107.

According to some examples, the charging connector 801 may be in the form of an electric cable, wire, group of wires, conduit, or combinations thereof. The charging connector 801 may include a jacket material, such as a urethane, polyurethane, rubber, plastic, nylon, another insulator material, or combinations thereof. The charging connector 801 may be rated for various voltages ranging from 100, 200, 220, 230, 240, 300, 400, 450, 500, 600 Volts, or more, and various currents ranging from 32, 63, 125 amps, and more. The charging connector 801 may also be configured for different power supplies ranging from 2 kW, 7 kW, 11 kW, 22 kW, 50 kW, or more. The charging connector 801 may have a single or multiple conductors of the same or different gauges. For example, the charging connector 801 may have two 18-gauge conductors, three, four, or up to five 2-gauge conductors. Different numbers, electric ratings, and combinations thereof of conductors will be recognized by those skilled in the art and are included herein.

The proximal end of the charging connector 801 may include the EV outlet charging interface 105 configured for insertion into one specific or multiple EV inlet charging interfaces 106 of the EV 112. For example, a plug at the proximal end of the charging connector 801 may be interchangeable with a different plug to interface with different ports, outlets, or sockets of the EV inlet charging interface 106 (or of different EVs 112). By way of another example, the plug may have a different number of pins or a specific shape depending on the type or version of the charging socket/plug. The plug may be configured for/as a North American Type 1 combined charging standard (CCS) (SAE J1772), a European Type 2 CCS (IEC 62196), a Tesla Model S, Model X, CCS and/or ChaDeMo adaptor, a Japanese ChaDeMo, a NEMA 14-SOP socket, or according to similar plug/socket charging standards.

Referring now to FIG. 10, a detailed view of the clamping element 107 attached to the charging connector 801 is depicted while the charging connector 801 and the EV outlet charging interface 105 assume a storage position 815. In some embodiments, the storage position 815 allows the EV outlet charging interface 105 to be approximately horizontally and vertically or laterally and vertically aligned with the charging position 816 depicted in FIG. 8. In other embodiments, the storage position 815 is at least horizontally aligned with the charging position 816, but not vertically aligned. In yet other embodiments, the storage position 815 is at least horizontally aligned but not laterally aligned with the charging position 816.

The tension reducing device 103 may be secured at one or more offset anchor points 104 using a wall anchor, nail, screw, bolt, nut, or combination of these or similar fasteners. At least one of the offset anchor points 104 may be offset relative to the power source 100. The attachment location of the clamping element 107 may be substantially vertically aligned with the offset anchor point 104 and tension reducing device 103 when in a storage position 815.

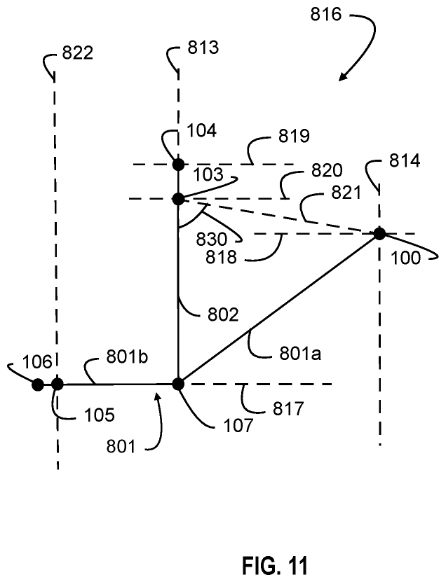

For example, referring now to FIG. 11, a first vertical axis 813 may pass vertically through the at least one offset anchor point 104 and may be parallel with the yaw axis and may be in substantial horizontal alignment with the clamping element 107 when the charging connector 801 assumes the charging position 816. A second vertical axis 814 may pass vertically through the charging power source 100 and may also be parallel with the yaw axis of the vehicle. The second vertical axis 814 may be separated from the first vertical axis 813 by a distance that is less than or equal to the length of the charging portion 801a.

A third vertical axis 822 may pass vertically through the EV outlet charging interface 105 when the charging connector 801 assumes the charging position 816 and may also be parallel with the yaw axis of the vehicle.

A first horizontal axis 817 may pass horizontally through the clamping element 107 and EV outlet charging interface 105 when the charging connector 801 assumes the charging position 816, and may be generally parallel with the supporting plane of the vehicle. A second horizontal axis 818 may pass horizontally through the charging power source 100 and may also be parallel with the supporting plane of the vehicle. A third horizontal axis 819 may pass horizontally through the at least one offset anchor point 104 and may also be parallel with the supporting plane of the vehicle. A fourth horizontal axis 820 may pass horizontally through the tension reducing device 103 and may also be parallel with the supporting plane of the vehicle.

The second horizontal axis 818 may located between the first horizontal axis 817 and the fourth horizontal axis 820. The third horizontal axis 819 may be a greater distance from the first horizontal axis 817 than the fourth horizontal axis 820 is from the first horizontal axis 817. The distance from the fourth horizontal axis 820 to the third horizontal axis 819 may depend on the configuration of the tension reducing device 103 and the types and/or locations of anchoring points previously described.

A first diagonal axis 821 may pass through the charging power source 100 and through the tension reducing device 103. The first diagonal axis 821 may define an angle 830 with respect to the first vertical axis 813. The angle 830 may be define by the following formula:

$$\\ A = {cos}^{- 1} ( \frac{{b}^{{}_{} 2} + {c}^{{}_{} 2} - {a}^{{}_{} 2}}{2 bc} )$$

where:
A=the angle 830;
a=the distance from power source 100 to the clamping element 107;
b=the distance from the tension reducing device 103 to the clamping element 107;
c=the distance from power source 100 to the tension reducing device 103.

The distance from power source 100 to the clamping element 107 may be less than or equal to the length of the charging portion 801a. The distance from the tension reducing device 103 to the clamping element 107 may be less than or equal to the length of the flexible support 802 in the charging position 816.

In the charging position 816, the first horizontal axis 817 may be generally the same distance from the supporting plane of the vehicle as the EV inlet charging interface 106. The distance from the first horizontal axis 817 to the fourth horizontal axis 820 may be less than or equal to the length of the flexible support 802. The distance from the first horizontal axis 817 to the second horizontal axis 818 may be less than or equal to the distance from the first horizontal axis 817 to the fourth horizontal axis 820.

The power source 100, the tension reducing device 103, and the clamping element 107 may be located in relation to each other so that, in the charging position 816, the tension applied to the EV inlet charging interface 106 by the EV outlet charging interface 105 is reduced.

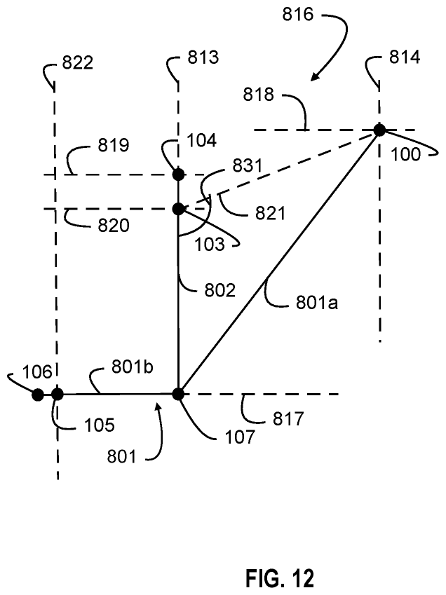

Referring now to FIG. 12, in an embodiment, a first vertical axis 813 may pass vertically through the at least one offset anchor point 104 and may be parallel with the yaw axis and may be in substantial horizontal alignment with the clamping element 107 when the charging connector 801 assumes the charging position 816. A second vertical axis 814 may pass vertically through the charging power source 100 and may also be parallel with the yaw axis of the vehicle. The second vertical axis 814 may be separated from the first vertical axis 813 by a distance that is less than the length of the charging portion 801a.

A third vertical axis 822 may pass vertically through the EV outlet charging interface 105 when the charging connector 801 assumes the charging position 816 and may also be parallel with the yaw axis of the vehicle.

A first horizontal axis 817 may pass horizontally through the clamping element 107 and EV outlet charging interface 105 when the charging connector 801 assumes the charging position 816, and may be generally parallel with the supporting plane of the vehicle. A second horizontal axis 818 may pass horizontally through the charging power source 100 and may also be parallel with the supporting plane of the vehicle. A third horizontal axis 819 may pass horizontally through the at least one offset anchor point 104 and may also be parallel with the supporting plane of the vehicle. A fourth horizontal axis 820 may pass horizontally through the tension reducing device 103 and may also be parallel with the supporting plane of the vehicle.

The distance from the first horizontal axis 817 to the second horizontal axis 818 may be greater than the distance from the first horizontal axis 817 to the fourth horizontal axis 820. The third horizontal axis 819 may be a greater distance from the first horizontal axis 817 than the fourth horizontal axis 820 is from the first horizontal axis 817. The distance from the fourth horizontal axis 820 to the third horizontal axis 819 may depend on the configuration of the tension reducing device 103 and the types and/or locations of anchoring points previously described.

A first diagonal axis 821 may pass through the charging power source 100 and through the tension reducing device 103. The first diagonal axis 821 may define an angle 831 with respect to the first vertical axis 813. The angle 831 may be define by the following formula:

$$\\ A = {cos}^{- 1} ( \frac{{b}^{{}_{} 2} + {c}^{{}_{} 2} - {a}^{{}_{} 2}}{2 bc} )$$

where:
A=the angle 831;
a=the distance from power source 100 to the clamping element 107;
b=the distance from the tension reducing device 103 to the clamping element 107;
c=the distance from power source 100 to the tension reducing device 103.

The distance from power source 100 to the clamping element 107 may be less than or equal to the length of the charging portion 801a. The distance from the tension reducing device 103 to the clamping element 107 may be less than or equal to the length of the flexible support 802 in the charging position 816.

In the charging position 816, the first horizontal axis 817 may be generally the same distance from the supporting plane of the vehicle as the EV inlet charging interface 106. The distance from the first horizontal axis 817 to the fourth horizontal axis 820 may be less than or equal to the length of the flexible support 802. The distance from the first horizontal axis 817 to the second horizontal axis 818 may be greater than the distance from the first horizontal axis 817 to the fourth horizontal axis 820.

The power source 100, the tension reducing device 103, and the clamping element 107 may be located in relation to each other so that, in the charging position 816, the tension applied to the EV inlet charging interface 106 by the EV outlet charging interface 105 is reduced.

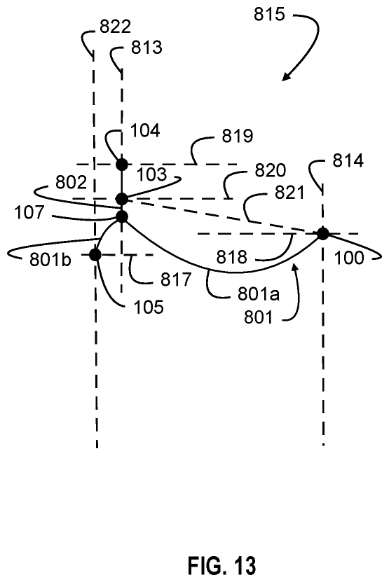

Referring now to FIG. 13, a first vertical axis 813 may pass vertically through the at least one offset anchor point 104 and may be parallel with the yaw axis and may be in substantial horizontal alignment with the clamping element 107 when the charging connector 801 assumes the storage position 815. A second vertical axis 814 may pass vertically through the charging power source 100 and may also be parallel with the yaw axis of the vehicle. The second vertical axis 814 may be separated from the first vertical axis 813 by a distance that is less than or equal to the length of the charging portion 801a.

A third vertical axis 822 may pass vertically through the EV outlet charging interface 105 when the charging connector 801 assumes the storage position 815 and may also be parallel with the yaw axis of the vehicle.

A first horizontal axis 817 may pass horizontally through the EV outlet charging interface 105 when the charging connector 801 assumes the storage position 815, and may be generally parallel with the supporting plane of the vehicle. A second horizontal axis 818 may pass horizontally through the charging power source 100 and may also be parallel with the supporting plane of the vehicle. A third horizontal axis 819 may pass horizontally through the at least one offset anchor point 104 and may also be parallel with the supporting plane of the vehicle. A fourth horizontal axis 820 may pass horizontally through the tension reducing device 103 and may also be parallel with the supporting plane of the vehicle.

The second horizontal axis 818 may located with respect to the tension reducing device 103 so that, in the storage position 815, the charging portion 801a is not in contact with the supporting plane of the electric vehicle 112. The third horizontal axis 819 may be a greater distance from the first horizontal axis 817 than the fourth horizontal axis 820 is from the first horizontal axis 817. The distance from the fourth horizontal axis 820 to the third horizontal axis 819 may depend on the configuration of the tension reducing device 103 and the types and/or locations of anchoring points previously described.

In the storage position 815, the first horizontal axis 817 may be a greater distance from the supporting plane of the vehicle than the distance from the supporting plane to the EV inlet charging interface 106. In the storage position, the first horizontal axis 817 may be located so that the EV outlet charging interface 105 is not in contact with the supporting plane of the electric vehicle 112.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together. The phrase “fluid communication” refers to two features that are connected such that a fluid within one feature can pass into the other feature.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements recited in means-plus-function format are intended to be construed in accordance with 35 U.S.C. § 112 Para. 6. It will be apparent to those having skill in the art that changes may be made to the details of the above-described embodiments without departing from the underlying principles set forth herein.

While specific embodiments and applications of the present disclosure have been illustrated and described, it is to be understood that the scope of this disclosure is not limited to the precise configuration and components disclosed herein. Various modifications, changes, and variations which will be apparent to those skilled in the art may be made in the arrangement, operation, and details of the methods and systems of the present disclosure set forth herein without departing from it in spirit and scope.

What is claimed is:

1. A system for cable tension management for charging an electric vehicle (EV) located proximate a power source attached to a first wall, a first support, or a first support beam, and a charging connector comprising a charging portion configured to be electrically connected to the power source, and a connection portion comprising an EV outlet charging interface configured to removably engage an EV inlet charging interface, the system comprising:
a tension reducing device, attached to a second wall, a second support, or a second support beam, comprising:
a flexible support; and
a clamping element;
wherein the clamping element is configured to couple the flexible support to the charging connector between the charging portion and the connection portion.

2. The system of claim 1, further comprising a storage position and a charging position.

3. The system of claim 2, wherein the power source, the tension reducing device, and the clamping element are located in relation to each other so that, in the charging position, tension applied to the EV inlet charging interface by the EV outlet charging interface is reduced or eliminated.

4. The system of claim 1, wherein the clamping element is electrically insulated.

5. The system of claim 1, wherein the clamping element comprises an insulator material and a semi-rigid portion.

6. The system of claim 1, wherein the tension reducing device comprises a positioner or a balancer.

7. The system of claim 1, wherein the charging portion has a greater length than the connection portion.

8. The system of claim 1, wherein a length of the connection portion is configured so that the flexible support supports the charging connector in a configuration that reduces or eliminates tension exerted on the charging connector and the EV outlet charging interface in a charging position.

9. The system of claim 1, wherein a length of the charging portion is greater than a length of the flexible support.

10. The system of claim 1, wherein the first wall, the first support, or the first support beam is a same wall, support, or support beam as the second wall, the second support, or the second support beam.

11. A system for cable tension management for charging an electric vehicle (EV) located proximate a power source attached to a first wall, a first support, or a first support beam, and a charging connector comprising a charging portion configured to be electrically connected to the power source, and a connection portion comprising an EV outlet charging interface configured to removably engage an EV inlet charging interface, the system comprising:
a tension reducing device, attached to a second wall, a second support, or a second support beam, comprising:
a flexible support; and
a clamping element;
wherein:
the system comprises a storage position and a charging position;
the clamping element is coupled to the charging connector and bisects the charging connector into the charging portion and the connection portion; and
a length of the connection portion is configured so that the flexible support supports the charging connector in a configuration that reduces or eliminates tension exerted on the connection portion and the EV outlet charging interface in the charging position.

12. The system of claim 11, wherein the power source, the tension reducing device, and the clamping element are located in relation to each other so that, in the charging position, tension applied to the EV inlet charging interface by the EV outlet charging interface is reduced or eliminated.

13. The system of claim 11, wherein the tension reducing device comprises a positioner or a balancer.

14. The system of claim 11, wherein the charging portion has a greater length than the connection portion.

15. The system of claim 11, wherein a length of the charging portion is greater than a length of the flexible support.

16. The system of claim 11, wherein the clamping element is insulated.

17. The system of claim 11, wherein the clamping element comprises an insulator material and a semi-rigid portion.

18. A method for cable tension management for electric vehicle (EV) charging comprising:
anchoring a tension reducing device to a wall or a support using an offset anchor point that is offset at a distance, less than a length of a charging connector or cable, from a power source, wherein the charging connector comprises a first end electrically connected to an EV outlet charging interface and a second end electrically connected to the power source;
attaching a clamping element to the charging connector at an offset distance from the EV outlet charging interface;
extending the EV outlet charging interface of the charging connector while applying a downward force to a retractable, flexible support that extends from the tension reducing device, wherein the flexible support extends away from the tension reducing device ipsilaterally relative to an EV inlet charging interface of the EV; and
performing one or more of:
suspending a weight of the EV outlet charging interface and attached charging connector from the clamping element and the flexible support, wherein tension is reduced or eliminated as a result of suspending the weight of the EV outlet charging interface and the offset distance attachment of the clamping element; and
continuing to apply the downward force during charging until charging the EV is complete and the EV outlet charging interface may be released, automatically retracting the flexible support into the tension reducing device.

19. The method of claim 18, further comprising applying an upward force to the EV outlet charging interface and the flexible support.

20. The method of claim 18, further comprising bringing the EV outlet charging interface and the charging connector into a storage position.
